(19) United States
(12) Patent Application Publication
(10) Pub. No.: US 2023/0130815 A1
(43) Pub. Date: Apr. 27, 2023

(54) IMAGE PROCESSING APPARATUS, IMAGE PROCESSING METHOD, AND PROGRAM

(71) Applicant: SONY GROUP CORPORATION, Tokyo (JP)

(72) Inventor: Takaaki KATO, Kanagawa (JP)

(73) Assignee: SONY GROUP CORPORATION, Tokyo (JP)

(21) Appl. No.: 17/908,771

(22) PCT Filed: Apr. 7, 2021
(86) PCT No.: PCT/JP2021/014705

§ 371 Date: Sep. 1, 2022

(30) Foreign Application Priority Data
Apr. 21, 2020 (JP) 2020-075333

(51) Int. Cl. G06T 7/73; G06F 3/01; G06F 3/16

(52) U.S. Cl. CPC G06T 7/73; G06F 3/016; G06F 3/167

(57) ABSTRACT

There is provided an image processing apparatus, an image processing method, and a program capable of detecting an obstacle in a virtual space that is not present in a real space. The image processing apparatus includes a detection unit that detects an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space. The present technology can be applied to, for example, image processing for a virtual camera system.

### TECHNICAL FIELD

The present technology relates to an image processing apparatus, an image processing method, and a program, and more particularly, relates to an image processing apparatus, an image processing method, and a program capable of detecting an obstacle in a virtual space that is not present in the real space.

### BACKGROUND ART

A system that provides an experience of the world of virtual reality (VR) uses a virtual camera having an imaging range corresponding to the viewing range of a viewer to allow the viewer to view a two-dimensional image through the virtual camera to see a three-dimensional object in a virtual space on a display apparatus such as an HMD (Head Mounted Display) (see, for example, PTL 1).

In recent years, a system has been developed in which a camera operator actually operates an imaging device corresponding to a virtual camera to image a three-dimensional object in a virtual space, and a two-dimensional image through the imaging device to see the three-dimensional object in the virtual space is created. This system is also called a virtual camera system or the like. According to the virtual camera system, the camera operator holds the real imaging device during operation, so that images through highly realistic camerawork can be created.

### CITATION LIST

### Patent Literature

[PTL 1]

JP 2018-45458 A

### SUMMARY

### Technical Problem

However, in the virtual camera system, the camera operator takes the image of a three-dimensional object that is not present in the real space, and therefore, there may be a situation where the camera operator in the real space moves to a place where a wall is present and the camera operator cannot move in the virtual space, for example.

The present technology has been made in view of such a situation, and makes it possible to detect an obstacle in a virtual space that is not present in the real space.

### Solution to Problem

An image processing apparatus according to one aspect of the present technology includes a detection unit that detects an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.

An image processing method according to one aspect of the present technology includes, by an image processing apparatus, detecting an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.

A program according to one aspect of the present technology causes a computer to execute processing of detecting an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.

According to one aspect of the present technology, an obstacle in a virtual space with respect to a virtual camera is detected based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.

The image processing apparatus according to one aspect of the present technology can be realized by causing a computer to execute a program. The program to be executed by the computer can be provided by transmitting through a transmission medium or by recording on a recording medium.

The image processing apparatus may be an independent apparatus or an internal block constituting one apparatus.

### BRIEF DESCRIPTION OF DRAWINGS

FIG. 1 is a diagram illustrating an overview of a virtual camera system.

FIG. 2 is a diagram illustrating an overview of the virtual camera system.

FIG. 3 is a diagram illustrating a possible problem in the virtual camera system.

FIG. 4 is a diagram illustrating an example of processing in an image processing system of FIG. 5.

FIG. 5 is a block diagram illustrating a configuration example of the image processing system to which the present technology is applied.

FIG. 6 is a diagram illustrating a screen example displayed on a display of an imaging device of FIG. 5.

FIG. 7 is a flowchart illustrating virtual space imaging processing performed by the image processing system of FIG. 5.

FIG. 8 is a flowchart illustrating obstacle-adaptive VC image creation processing.

FIG. 9 is a diagram illustrating first obstacle determination processing to third obstacle determination processing.

FIG. 10 is a diagram illustrating fourth obstacle determination processing.

FIG. 11 is a diagram illustrating VC image creation processing in which transparency processing is performed.

FIG. 12 is a diagram illustrating VC image creation processing in which transparency processing is performed.

FIG. 13 is a diagram illustrating position change control for a third avoidance mode.

FIG. 14 is a block diagram illustrating a modification example of the image processing system of FIG. 5.

FIG. 15 is a block diagram illustrating another configuration example of the imaging device.

FIG. 16 is a block diagram illustrating a configuration example of an embodiment of a computer to which the present technology is applied.

### DESCRIPTION OF EMBODIMENTS

Modes for embodying the present technology (hereinafter referred to as embodiments) will be described below with reference to the accompanying drawings. In the present specification and the drawings, components having substantially the same functional configuration will be denoted by the same reference numerals, and thus repeated descriptions thereof will be omitted. The description will be made in the following order.

1. Overview of virtual camera system

2. Configuration example of image processing system

3. Virtual space imaging processing in image processing system

4. Modification example of image processing system

5. Configuration example of single imaging device

6. Configuration example of computer

### 1. Overview of Virtual Camera System

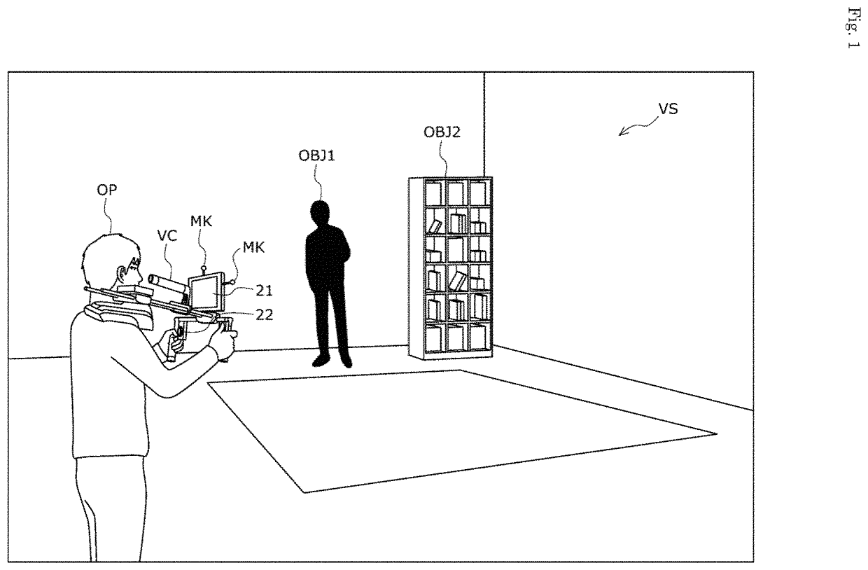

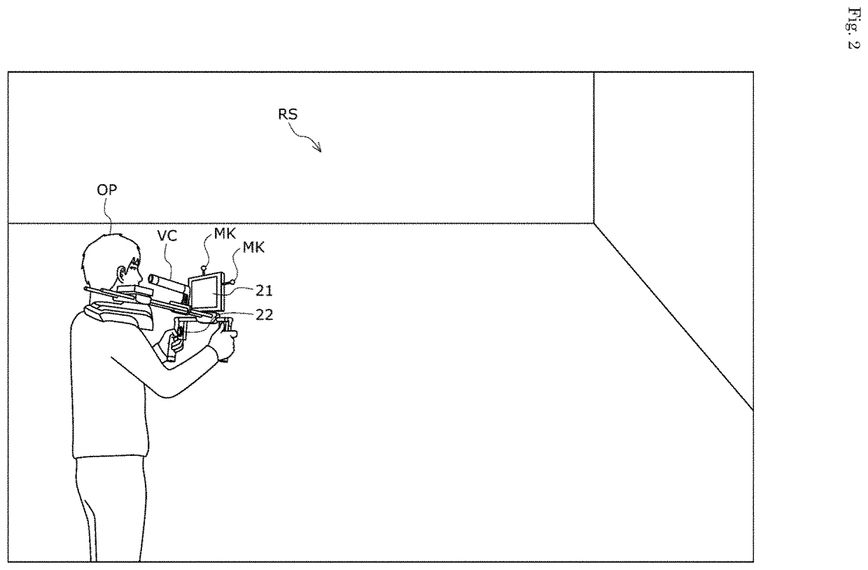

First, the overview of a virtual camera system in which an image processing system according to the present technology is used will be described with reference to FIGS. 1 and 2.

As illustrated in FIG. 1, a camera operator OP actually operates an imaging device VC to take the image of a three-dimensional object OBJ in a virtual space VS. In the example of FIG. 1, a person OBJ1 and a bookshelf OBJ2 are arranged as three-dimensional objects OBJ in the virtual space VS. The three-dimensional objects OBJ including the person OBJ1 and the bookshelf OBJ2 are defined by 3D model data in which each object is represented by a 3D model. The person OBJ1 is a subject of interest that the camera operator OP pays attention to and takes the image in the virtual space VS, and the bookshelf OBJ2 is a surrounding subject other than the subject of interest and is also a background image of the person OBJ1.

When the camera operator OP operates the imaging device VC to take the image of the person OBJ1 that is the subject of interest from various angles, an imaging apparatus (not illustrated) captures the image of a plurality of markers MK mounted on the imaging device VC, and detects the position and attitude of the imaging device VC. Then, an imaging range of the imaging device VC is calculated according to the position and attitude of the imaging device VC, and a two-dimensional image obtained by rendering the three-dimensional object OBJ on the virtual space VS corresponding to the imaging range of the imaging device VC is displayed on a display 21 of the imaging device VC. Specifically, the movement of the imaging device VC actually operated by the camera operator OP is regarded as the movement of a virtual camera, and a two-dimensional image corresponding to the three-dimensional object OBJ viewed from the virtual camera is displayed on the display 21. The camera operator OP determines the angle of the subject of interest for imaging while viewing the two-dimensional image corresponding to the three-dimensional object OBJ displayed on the display 21. The camera operator OP can operate an operation switch 22 provided on the imaging device VC to perform zoom operation, white balance (WB) adjustment, exposure adjustment, and the like.

According to such a virtual camera system, the camera operator OP holds the real imaging device VC during operation, so that images through highly realistic camerawork can be created.

<Possible Problem>

However, the camera operator OP actually performs image capturing in a real space RS where nothing exists, as illustrated in FIG. 2. Therefore, the following situations can occur due to the difference between the real space RS and the virtual space VS.

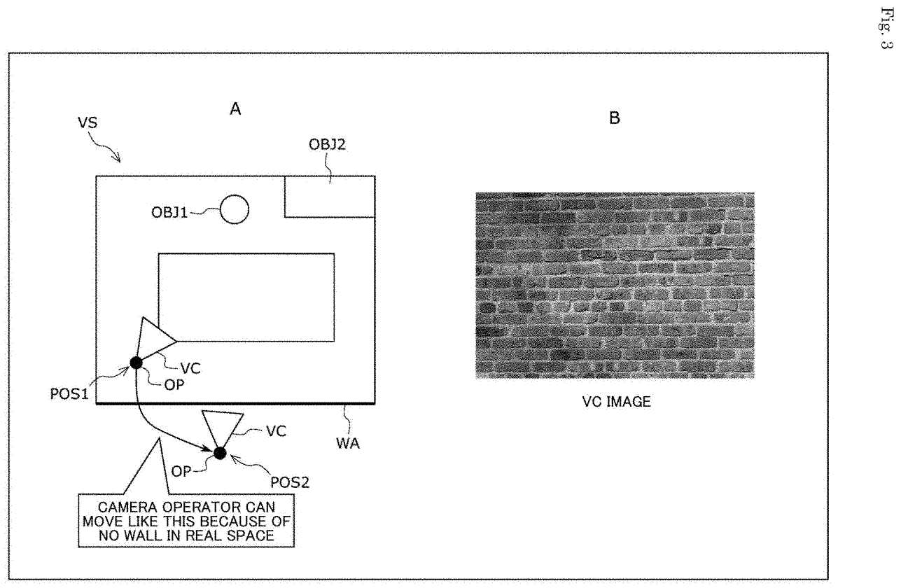

A of FIG. 3 is a top view of a state in which the camera operator OP of FIG. 1 is capturing an image of the virtual space VS as viewed from above.

In the virtual space VS, there is a wall WA that surrounds all sides outside the person OBJ1 and the bookshelf OBJ2.

It is here assumed that the camera operator OP in the real space RS has moved from a position POS1 in the virtual space VS to take the image of the person OBJ1 that is the subject of interest by using the imaging device VC to a position POS2 in the virtual space VS. In addition, it is assumed that the positional relation between the camera operator OP and the imaging device VC remains unchanged.

As illustrated in FIG. 2, since there is no particularly obstructive object in the real space RS, the camera operator OP can easily move from the position POS1 to the position POS2 in the virtual space VS.

However, in the virtual space VS, since the position POS2 is outside the wall WA, the two-dimensional image displayed on the display 21 based on the position and attitude of the imaging device VC is not the image of the person OBJ1, which is originally intended to be captured, but the image of the wall WA as illustrated in B of FIG. 3. Hereinafter, a rendered image of the virtual space VS based on the position and attitude of the imaging device VC, which is created as an image captured by the imaging device VC, is also referred to as a VC image.

In this way, due to the difference between the real space RS and the virtual space VS, a situation may occur in which the camera operator OP takes the image of an object different from an object whose image is originally intended to be captured.

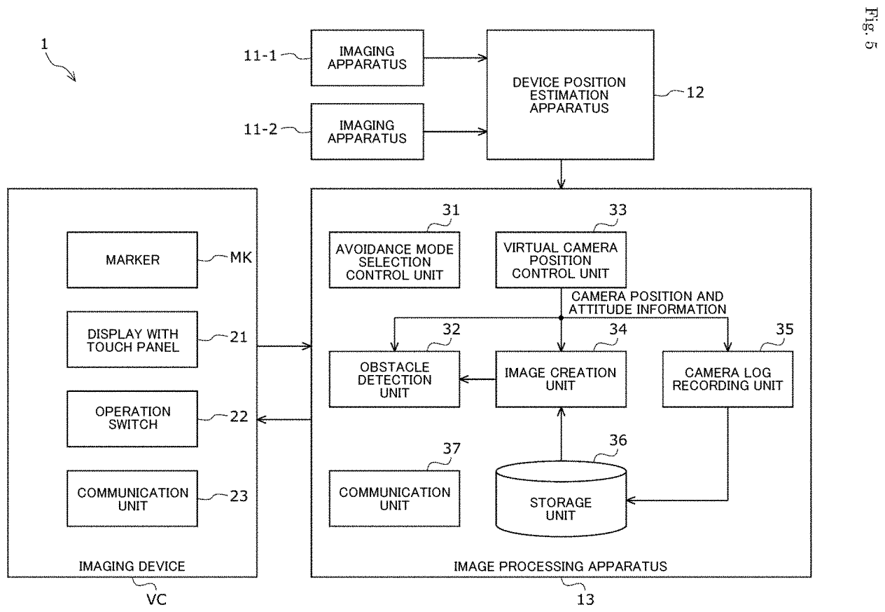

The image processing system according to the present technology (an image processing system 1 in FIG. 5) described below is a system incorporating a technology for preventing such a failure in imaging.

In the following, an example of the wall WA will be described as an obstacle through which the camera operator OP cannot originally pass or which is not movable in the virtual space VS, according to the example of FIG. 3, but the obstacle is not limited to the wall.

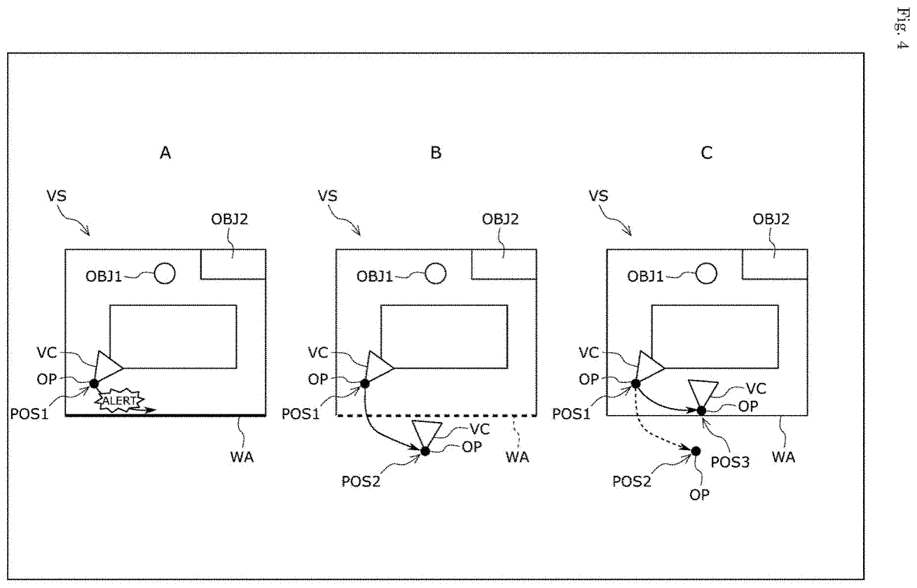

FIG. 4 illustrates an example of processing (function) included in the image processing system 1 of FIG. 5 in order to avoid the failure in imaging as described with reference to FIG. 3.

The image processing system 1 can select and execute any one of three avoidance modes A to C in FIG. 4.

A of FIG. 4 illustrates an example of first avoidance processing provided by the image processing system 1 as a first avoidance mode.

In the first avoidance mode, when the image processing system 1 predicts that the camera operator OP to collide with an obstacle in the virtual space VS from the position POS1 of the camera operator OP in the real space RS, the image processing system 1 notifies by any means the camera operator OP that the camera operator OP possibly collides with the obstacle. As a means for notifying, various methods may be adopted such as displaying a message on the display 21, outputting a sound such as an alarm sound, and vibrating the imaging device VC. The camera operator OP can take avoidance behavior so as not to hit the wall WA in response to an alert notification from the image processing system 1.

B of FIG. 4 illustrates an example of second avoidance processing provided by the image processing system 1 as a second avoidance mode.

In the second avoidance mode, when the position of the camera operator OP in the real space RS moves from the position POS1 in the virtual space VS to the position POS2 outside the wall WA, the image processing system 1 determines that the wall WA does not serve as an obstacle, and then performs transparency processing of temporarily making the wall WA transparent. This makes it possible to capture an image of the person OBJ1 that is beyond the wall WA.

C of FIG. 4 illustrates an example of third avoidance processing provided by the image processing system 1 as a third avoidance mode.

In the third avoidance mode, when the position of the camera operator OP in the real space RS moves from the position POS1 in the virtual space VS to the position POS2 outside the wall WA, the image processing system 1 changes the amount of movement of the virtual camera in the virtual space VS corresponding to the amount of movement of the camera operator OP in the real space RS. Specifically, when the camera operator OP moves from the position POS1 to the position POS2 in the real space RS, the image processing system 1 changes the ratio between the amount of movement in the real space RS and the amount of movement in the virtual space VS as if the camera operator OP moves to a position POS3 inside the wall WA in the virtual space VS. As a result, the position of the virtual camera is inside the wall WA, so that it is possible to capture an image of the person OBJ1.

### 2. Configuration Example of Image Processing System

FIG. 5 is a block diagram illustrating a configuration example of the image processing system which performs the above-described first avoidance processing to third avoidance processing and to which the present technology is applied.

The image processing system 1 of FIG. 5 includes the imaging device VC, two imaging apparatuses 11 (11-1, 11-2), a device position estimation apparatus 12, and an image processing apparatus 13.

The imaging device VC is a device that captures an image of the virtual space VS illustrated in FIG. 1 and the like, and includes markers MK, the display 21 with a touch panel, the operation switch 22, and a communication unit 23.

As illustrated in FIG. 1, the plurality of markers MK, which are provided on the imaging device VC, are to be imaged by the two imaging apparatuses 11. The markers MK are provided for detecting the position and attitude of the imaging device VC in the real space RS.

The display 21 with a touch panel includes an LCD (Liquid Crystal Display) or an organic EL (Electro Luminescence) display on which the touch panel is placed, detects a touch operation on the screen from the camera operator OP, and displays a predetermined image such as a two-dimensional image obtained by rendering a 3D object(s) in the virtual space VS. The display 21, but having not been described in detail with reference to FIG. 1, is a display with a touch panel, and hereinafter, the display 21 with a touch panel is simply referred to as the display 21.

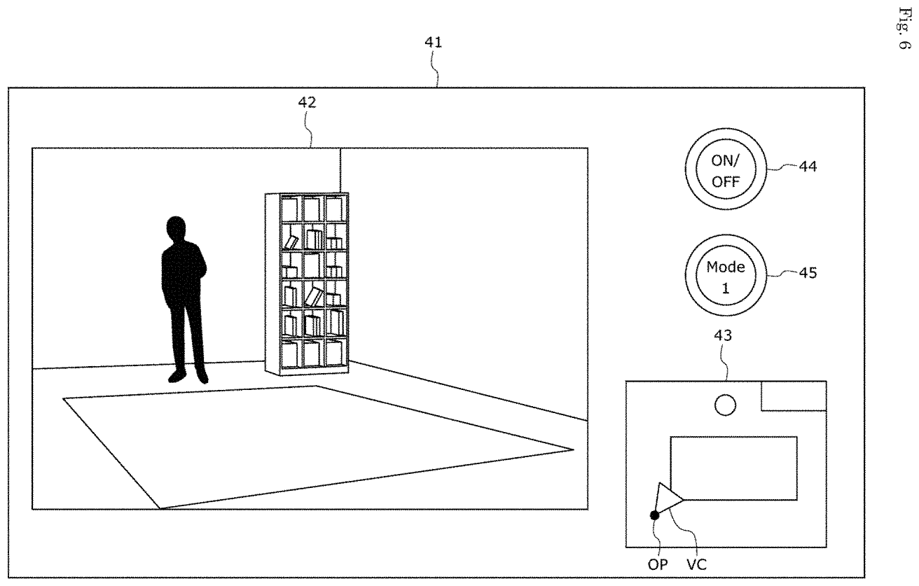

FIG. 6 illustrates a screen example displayed on the display 21 of the imaging device VC while the camera operator OP is capturing an image of the virtual space VS.

A screen 41 of FIG. 6 includes a rendered image display section 42, a top view display section 43, an avoidance mode on/off button 44, and an avoidance mode switching button 45.

In the rendered image display section 42, a two-dimensional image (VC image) obtained when the imaging device VC as a virtual camera captures an image of the virtual space VS is displayed according to the position and attitude of the imaging device VC.

In the top view display section 43, a top view image corresponding to a top view of the virtual space VS as viewed from above is displayed. The top view image also includes the position in the virtual space VS of the camera operator OP in the real space RS and the imaging direction of the imaging device VC.

The avoidance mode on/off button 44 is a button for switching between enabling and disabling the first to third avoidance modes described above.

The avoidance mode switching button 45 is a button for switching between the first to third avoidance modes described above. The avoidance mode switching button 45 switches the mode in the order of the first avoidance mode, the second avoidance mode, and the third avoidance mode each time the button is touched, for example. The avoidance mode switching button 45 functions as a selection unit for selecting a method of avoiding an obstacle.

The camera operator OP who is the user of the imaging device VC can touch the avoidance mode on/off button 44 to switch the avoidance mode on/off, and touch the avoidance mode switching button 45 to switch between the first to third avoidance modes. Alternatively, the avoidance mode on/off button 44 and the avoidance mode switching button 45 may be provided on the imaging device VC as hardware buttons instead of on the screen.

Returning to the description with reference to FIG. 5, the operation switch 22 includes various types of hardware switches such as operation buttons, directional keys, a joystick, a handle, a pedal, or a lever, to generate an operation signal corresponding to the operation from the camera operator OP and supply the signal to the image processing apparatus 13 via the communication unit 23. The operation switch 22 is a switch capable of performing image adjustment such as zoom operation, white balance (WB) adjustment, and exposure adjustment.

The communication unit 23 includes a communication interface for performing wired communication such as LAN (Local Area Network) and HDMI (registered trademark) or wireless communication such as wireless LAN and Bluetooth (registered trademark), to transmit and receive predetermined data to and from the image processing apparatus 13. For example, the communication unit 23 receives the image data of a two-dimensional image obtained by rendering a 3D object(s), supplied from the image processing apparatus 13, and supplies the image data to the display 21. Further, for example, the communication unit 23 transmits to the image processing apparatus 13 an operation signal corresponding to the operation of on/off of the avoidance mode, the operation of switching between the first to third avoidance modes, and the adjustment operation through an operation of the operation switch 22.

As described above, the imaging device VC includes an operation unit for performing image adjustment similar to that of a real imaging apparatus, and the image to be adjusted is a rendered image to be displayed on the display 21.

The two imaging apparatuses 11 (11-1, 11-2) are arranged at different positions in the real space RS to capture images of the real space RS from different directions. The imaging apparatuses 11 supply the captured images obtained as results of imaging to the device position estimation apparatus 12. The captured images captured by the imaging apparatuses 11 includes, for example, the plurality of markers MK of the imaging device VC.

In the configuration example of FIG. 5, the image processing system 1 is configured to include the two imaging apparatuses 11. However, the image processing system 1 may include one or three or more imaging apparatuses 11. A larger number of imaging apparatuses 11 for capturing images of the real space RS can capture the markers MK of the imaging device VC from more various directions, which makes it possible to improve the detection accuracy of the position and attitude of the imaging device VC. Further, the imaging apparatus 11 may have a distance measuring function for measuring the distance to the subject in addition to the imaging function, or may be provided with a distance measuring apparatus separate from the imaging apparatus 11.

The device position estimation apparatus 12 is an apparatus that tracks the markers MK of the imaging device VC to estimate the position and attitude of the imaging device VC. The device position estimation apparatus 12 recognizes the markers MK included in the captured images supplied from the two imaging apparatuses 11, and detects the position and attitude of the imaging device VC from the positions of the markers MK. The device position estimation apparatus 12 supplies device position and attitude information indicating the position and attitude of the detected imaging device VC to the image processing apparatus 13.

The image processing apparatus 13 is configured to include an avoidance mode selection control unit 31, an obstacle detection unit 32, a virtual camera position control unit 33, an image creation unit 34, a camera log recording unit 35, a storage unit 36, and a communication unit 37.

The avoidance mode selection control unit 31 acquires information related to the enable/disable of the avoidance mode and the first to third avoidance modes, which are set by the camera operator OP operating the avoidance mode on/off button 44 and the avoidance mode switching button 45 of the imaging device VC, via the communication unit 37, and controls the units of the image processing apparatus 13 according to the acquired avoidance mode setting information.

Specifically, when the avoidance mode is set to be disabled, the avoidance mode selection control unit 31 controls the units of the image processing apparatus 13 so that the avoidance processing is not executed.

Further, when the avoidance mode is enabled and the first avoidance mode is selected, the avoidance mode selection control unit 31 causes the image creation unit 34 to create an alert screen according to the result of detecting an obstacle.

Furthermore, when the avoidance mode is enabled and the second avoidance mode is selected, the avoidance mode selection control unit 31 causes the image creation unit 34 to create a VC image in which transparency processing is performed on an obstacle according to the result of detecting the obstacle.

Further, when the avoidance mode is enabled and the third avoidance mode is selected, the avoidance mode selection control unit 31 causes the virtual camera position control unit 33 to change the position of the virtual camera corresponding to the position of the imaging device VC in the real space RS according to the result of detecting an obstacle.

The obstacle detection unit 32 receives camera position and attitude information indicating the position and attitude of the virtual camera from the virtual camera position control unit 33, and also receives position information indicating the position of each three-dimensional object OBJ in the virtual space VS from the image creation unit 34.

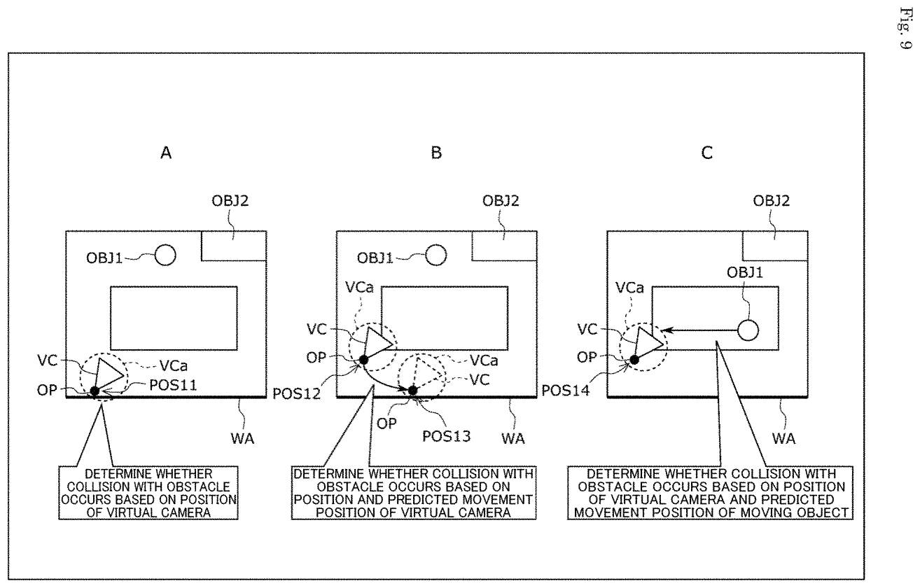

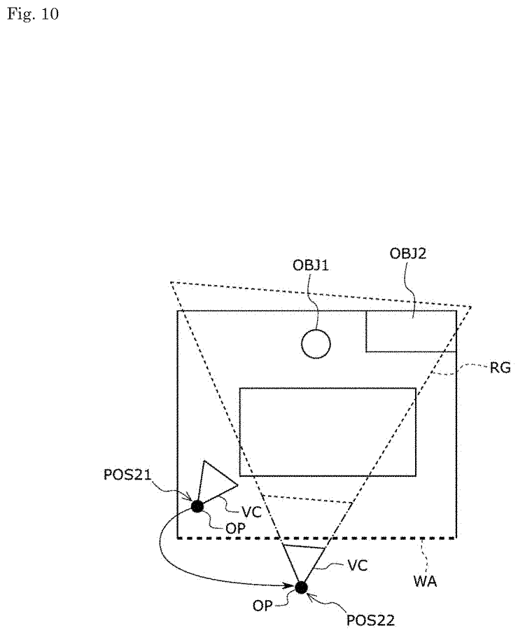

The obstacle detection unit 32 detects an obstacle in the virtual space VS with respect to the virtual camera based on the position and attitude of the virtual camera and the position of the three-dimensional object OBJ in the virtual space VS. A method for the obstacle detection will be described later in detail with reference to FIGS. 9 and 10. When an obstacle is detected, the obstacle detection unit 32 supplies information indicating that the obstacle has been detected to the virtual camera position control unit 33 or the image creation unit 34 according to the avoidance mode.

Under the control of the avoidance mode selection control unit 31, the obstacle detection unit 32 performs obstacle detection processing when the avoidance mode is enabled, and does not perform the obstacle detection processing when the avoidance mode is disabled.

The virtual camera position control unit 33 identifies the position and attitude of the virtual camera based on the device position and attitude information indicating the position and attitude of the imaging device VC, supplied from the device position estimation apparatus 12.

The virtual camera position control unit 33 basically generates camera position and attitude information in which the position and attitude of the imaging device VC supplied from the device position estimation apparatus 12 is used as the position and attitude of the virtual camera, and supplies the camera position and attitude information to the obstacle detection unit 32, the image creation unit 34, and the camera log recording unit 35.

However, in the case where the third avoidance mode is selected and controlled by the avoidance mode selection control unit 31, when an obstacle is detected, the virtual camera position control unit 33 changes a change in the position of the virtual camera corresponding to a change in the position of the imaging device VC in the real space RS.

The image creation unit 34 creates a display image to be displayed on the display 21 of the imaging device VC, for example, the screen 41 illustrated in FIG. 6. For example, the image creation unit 34 creates a VC image to be displayed on the rendered image display section 42 of the screen 41 of FIG. 6, a top view image to be displayed on the top view display section 43, and the like.

The image creation unit 34 receives 3D object data, which is the data of the three-dimensional object OBJ, from the storage unit 36, and also receives the camera position and attitude information indicating the position and attitude of the virtual camera from the virtual camera position control unit 33. Note that which piece of 3D object data is to be reproduced of the plurality of pieces of 3D object data stored in the storage unit 36 is determined by the user specifying it with an operation unit (not illustrated).

The image creation unit 34 creates a VC image that is a part, corresponding to the imaging range of the virtual camera, of the three-dimensional object OBJ based on the 3D object data. Further, in the case where the first avoidance mode is selected and executed as the avoidance mode, when an obstacle is detected, the image creation unit 34 creates an alert screen according to the control of the avoidance mode selection control unit 31. For example, the alert screen may be a screen in which the display method has been changed by changing the created VC image to red, or may be a screen in which a message dialog such as “An obstacle is present” is superimposed on the created VC image.

The image creation unit 34 also creates a top view image to be displayed on the top view display section 43 of the screen 41 of FIG. 6. The created VC image and top view image are supplied to the imaging device VC via the communication unit 37.

In addition, the image creation unit 34 creates position information indicating the position of the three-dimensional object OBJ in the virtual space VS and supplies the position information to the obstacle detection unit 32.

The camera log recording unit 35 records (stores) the camera position and attitude information indicating the position and attitude of the virtual camera, supplied from the virtual camera position control unit 33, in the storage unit 36 as log information indicating the track of the virtual camera.

The storage unit 36 stores a plurality of pieces of 3D object data, and supplies a piece of 3D object data specified by the user through an operation unit (not illustrated) to the image creation unit 34. Further, the storage unit 36 stores the log information of the virtual camera supplied from the camera log recording unit 35.

The communication unit 37 communicates by a method corresponding to the communication method performed by the communication unit 23 of the imaging device VC. The communication unit 37 transmits to the imaging device VC the VC image and the top view image created by the image creation unit 34, and also receives from the imaging device VC operation signals of the avoidance mode on/off button 44 and the avoidance mode switching button 45, and an operation signal of the operation switch 22.

The image processing system 1 configured as described above executes virtual space imaging processing in which a two-dimensional image of the virtual space VS is created which is taken by the camera operator OP in the real space RS with the imaging device VC, and the two-dimensional image is displayed on (the rendered image display section 42 of) the display 21 of the imaging device VC. The virtual space imaging processing executed by the image processing system 1 will be described below in more detail.

### 3. Virtual Space Imaging Processing in Image Processing System

<For Avoidance Mode Being Disabled>

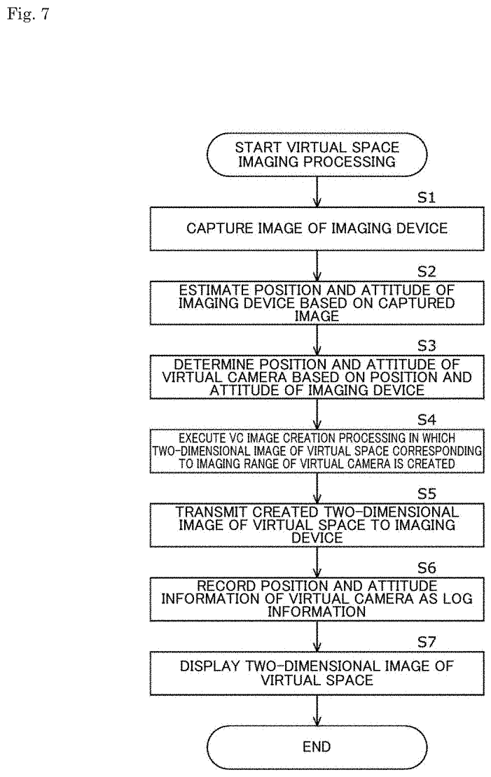

First, referring to the flowchart of FIG. 7, the virtual space imaging processing will be described for the avoidance mode being disabled by the avoidance mode on/off button 44, in other words, for no consideration of collision between the virtual camera and an obstacle.

This processing is started, for example, in response to an operation to start capturing an image of the virtual space VS in the image processing system 1 through the operation unit of the image processing apparatus 13. Note that which piece of 3D object data is to be read to form the virtual space VS of the plurality of pieces of 3D object data stored in the storage unit 36 has been determined by an operation prior to the start of the processing of FIG. 7.

First, in step S1, each of the plurality of imaging apparatuses 11 captures an image of the imaging device VC being operated by the camera operator OP in the real space RS, and supplies the resulting captured image to the device position estimation apparatus 12.

In step S2, the device position estimation apparatus 12 estimates the position and attitude of the imaging device VC based on the captured images supplied from the respective imaging apparatuses 11. More specifically, the device position estimation apparatus 12 recognizes the plurality of markers MK appearing in the captured images supplied from the respective imaging apparatuses 11, and detects the positions and attitudes of the markers MK in the real space RS, thereby estimating the position and attitude of the imaging device VC. The estimated position and attitude of the imaging device VC are supplied to the image processing apparatus 13 as device position and attitude information.

In step S3, the virtual camera position control unit 33 determines the position and attitude of the virtual camera based on the position and attitude of the imaging device VC supplied from the device position estimation apparatus 12. Specifically, the virtual camera position control unit 33 supplies the camera position and attitude information, which indicates the position and attitude of the virtual camera and in which the position and attitude of the imaging device VC supplied from the device position estimation apparatus 12 is used as the position and attitude of the virtual camera, to the obstacle detection unit 32, the image creation unit 34, and the camera log recording unit 35.

In step S4, the image creation unit 34 executes VC image creation processing in which a two-dimensional image (VC image) of the virtual space VS corresponding to the imaging range of the virtual camera is created.

In step S5, the communication unit 37 transmits the two-dimensional image of the virtual space VS created by the image creation unit 34 to the imaging device VC.

In step S6, the camera log recording unit 35 records the camera position and attitude information indicating the position and attitude of the virtual camera, supplied from the virtual camera position control unit 33, in the storage unit 36 as log information indicating the track of the virtual camera.

The processing of steps S5 and S6 may be performed in reverse order or may be executed in parallel.

In step S7, the display 21 of the imaging device VC acquires and displays the two-dimensional image of the virtual space VS transmitted from the image processing apparatus 13 via the communication unit 23.

The processing of the series of steps S1 to S7 described above is continuously executed until the operation to end the imaging of the virtual space VS.

<For Avoidance Mode Being Enabled>

Next, the virtual space imaging processing will be described for the avoidance mode being enabled by the avoidance mode on/off button 44.

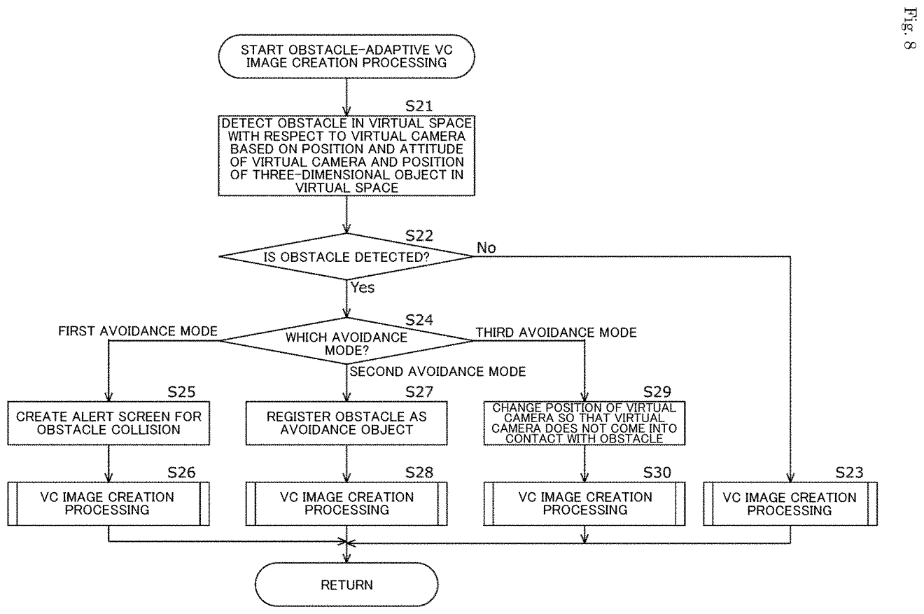

In the virtual space imaging processing for the avoidance mode being enabled, the VC image creation processing executed in step S4 of the flowchart of the virtual space imaging processing in FIG. 7 is replaced with the obstacle-adaptive VC image creation processing in FIG. 8, and the other processing is the same as steps S1 to S3 and S5 to S7. Therefore, with reference to the flowchart of FIG. 8, the obstacle-adaptive VC image creation processing will be described to be executed as the processing of step S4 of the virtual space imaging processing in FIG. 7 for the avoidance mode being set to be enabled.

First, in step S21, the obstacle detection unit 32 acquires the camera position and attitude information supplied from the virtual camera position control unit 33 and the position information, which indicates the position of the three-dimensional object OBJ in the virtual space VS, supplied from the image creation unit 34. Then, the obstacle detection unit 32 detects an obstacle in the virtual space VS with respect to the virtual camera based on the position and attitude of the virtual camera and the position of the three-dimensional object OBJ in the virtual space VS.

Here, a determination method in obstacle detection in step S21 will be described with reference to FIGS. 9 and 10. In the description with reference to FIGS. 9 and 10, for the sake of simplicity, for example, the “position” of the virtual camera as used herein, in which the “attitude” is not referred to. However, the determination in obstacle detection involves not only the position of the virtual camera but also the attitude, as a matter of course.

The obstacle detection unit 32 detects whether or not an obstacle is present with respect to the virtual camera in the virtual space VS by, for example, executing four ways of obstacle determination processing illustrated in FIGS. 9 and 10. States A to C of FIG. 9 are states before the avoidance processing for avoiding the obstacle is executed, and accordingly, the position of the imaging device VC corresponds to the position of the virtual camera. Further, the positional relation between the camera operator OP and the imaging device VC remains unchanged.

A of FIG. 9 is a diagram illustrating first obstacle determination processing.

In the first obstacle determination processing, the obstacle detection unit 32 determines whether a collision with an obstacle occurs based on the relationship between the position of the virtual camera (imaging device VC) and the position of the three-dimensional object OBJ in the virtual space VS.

Specifically, the obstacle detection unit 32 sets a predetermined range as a range VCa of collision with an obstacle on the basis of the position of the virtual camera (imaging device VC), and when a predetermined three-dimensional object OBJ in the virtual space VS is in the collision range VCa, detects the three-dimensional object OBJ as an obstacle.

In the example of A of FIG. 9, the virtual camera is present at the position POS11 in the virtual space VS, and the wall WA, which is a three-dimensional object OBJ, is present in the collision range VCa, so that the wall WA is detected as an obstacle.

B of FIG. 9 is a diagram illustrating second obstacle determination processing.

In the second obstacle determination processing, the obstacle detection unit 32 determines whether a collision with an obstacle occurs based on the relationship between the position and a predicted movement position of the virtual camera (imaging device VC) and the position of the three-dimensional object OBJ in the virtual space VS.

Specifically, the obstacle detection unit 32 predicts the position of the virtual camera (predicted movement position) in a predetermined time after the virtual camera moves from the current position, based on the path of movement of the virtual camera (imaging device VC) from the predetermined time before to the present. Then, when the predetermined three-dimensional object OBJ in the virtual space VS is in the collision range VCa for the predicted movement position, the obstacle detection unit 32 detects the three-dimensional object OBJ as an obstacle.

In the example of B of FIG. 9, it is predicted that the virtual camera will move from a current position POS12 to a position POS13 in a predetermined time, and the wall WA, which is a three-dimensional object OBJ, is present in the collision range VCa for the position POS13, so that the wall WA is detected as an obstacle.

C of FIG. 9 is a diagram illustrating third obstacle determination processing.

In the third obstacle determination processing, the obstacle detection unit 32 determines whether a collision with an obstacle occurs based on the relationship between the position of the virtual camera (imaging device VC) and the predicted movement position of the three-dimensional object OBJ moving in the virtual space VS.

Specifically, when the three-dimensional object OBJ moving in the virtual space VS is present as a moving object, the obstacle detection unit 32 predicts the path of movement of the moving object. Then, when the predicted path of movement of the moving object is in the collision range VCa of the virtual camera, the obstacle detection unit 32 detects the three-dimensional object OBJ as an obstacle.

In the example of C of FIG. 9, the virtual camera is present at a position POS14 in the virtual space VS, and the path of movement of the person OBJ1 as a moving object is in the collision range VCa of the virtual camera, so that the person OBJ1 is detected as an obstacle.

FIG. 10 is a diagram illustrating fourth obstacle determination processing.

In the fourth obstacle determination processing, an object that does not causes a collision as an obstacle but may be an obstacle to the imaging of the subject of interest is detected as an obstacle.

For example, as illustrated in FIG. 10, in the state where the virtual camera (imaging device VC) passes through the doorway of an indoor room provided in the virtual space VS from a current position POS21 and moves to an outdoor position POS22 in a predetermined time, the VC image as illustrated in B of FIG. 3 is created due to the presence of the wall WA, when the virtual camera captures an image of the person OBJ1, which is the subject of interest, at the position POS22.

Therefore, the obstacle detection unit 32 detects an obstacle based on the position of the virtual camera and the positional relationship between the subject of interest for the imaging device VC in the virtual space VS and a neighboring subject which is a subject around the subject of interest.

Specifically, when a predetermined three-dimensional object OBJ is present outside the region of a viewing frustum RG, which is the imaging range of the virtual camera, and between the virtual camera and the subject of interest, the obstacle detection unit 32 detects the three-dimensional object OBJ as an obstacle.

In the example of FIG. 10, the virtual camera is present at the position POS22 in the virtual space VS, and the wall WA is present outside the region of the viewing frustum RG, which is the imaging range of the virtual camera, and between the virtual camera and the person OBJ1, which is the subject of interest, so that the wall WA is detected as an obstacle.

Returning to the flowchart of FIG. 8, in step S21, the obstacle detection unit 32 detects an obstacle in the virtual space VS with respect to the virtual camera by executing the above-mentioned first to fourth obstacle determination processing.

Then, in step S22, the obstacle detection unit 32 determines whether an obstacle is detected.

If it is determined in step S22 that no obstacle is detected, the processing proceeds to step S23, and the image creation unit 34 executes the VC image creation processing in which a two-dimensional image (VC image) of the virtual space VS corresponding to the imaging range of the virtual camera is created. This VC image creation processing is the same processing as step S4 of FIG. 7.

On the other hand, if it is determined in step S22 that an obstacle has been detected, the processing proceeds to step S24, and the avoidance mode selection control unit 31 determines which of the first to third avoidance modes is selected as the avoidance mode.

In step S24, if it is determined that the first avoidance mode is selected as the avoidance mode, the processing proceeds to step S25; if it is determined that the second avoidance mode is selected as the avoidance mode, the processing proceeds to step S27; and if it is determined that the third avoidance mode is selected as the avoidance mode, the processing proceeds to step S29.

In step S25 for the first avoidance mode being selected as the avoidance mode, the avoidance mode selection control unit 31 causes the image creation unit 34 to create an alert screen for obstacle collision. The image creation unit 34 creates the alert screen according to the control of the avoidance mode selection control unit 31, and transmits the alert screen to the imaging device VC via the communication unit 37. For example, the alert screen may be a screen without any character in which the created VC image has been changed to red, or may be a screen in which a message dialog such as “An obstacle is present” is superimposed on the created VC image.

In step S26, the image creation unit 34 executes the same VC image creation processing as step S4 of FIG. 7.

On the other hand, in step S27 for the second avoidance mode being selected as the avoidance mode, the avoidance mode selection control unit 31 registers the detected obstacle as an avoidance object and notifies the image creation unit 34 of the avoidance object.

In step S28, the image creation unit 34 executes the VC image creation processing in which transparency processing is performed on the avoidance object notified from the avoidance mode selection control unit 31, and a two-dimensional image (VC image) of the virtual space VS corresponding to the imaging range of the virtual camera is created.

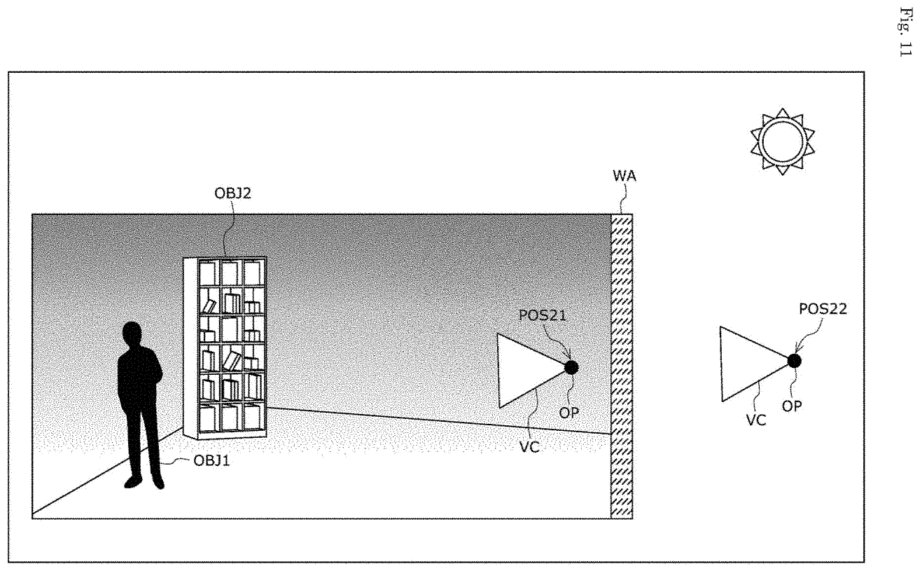

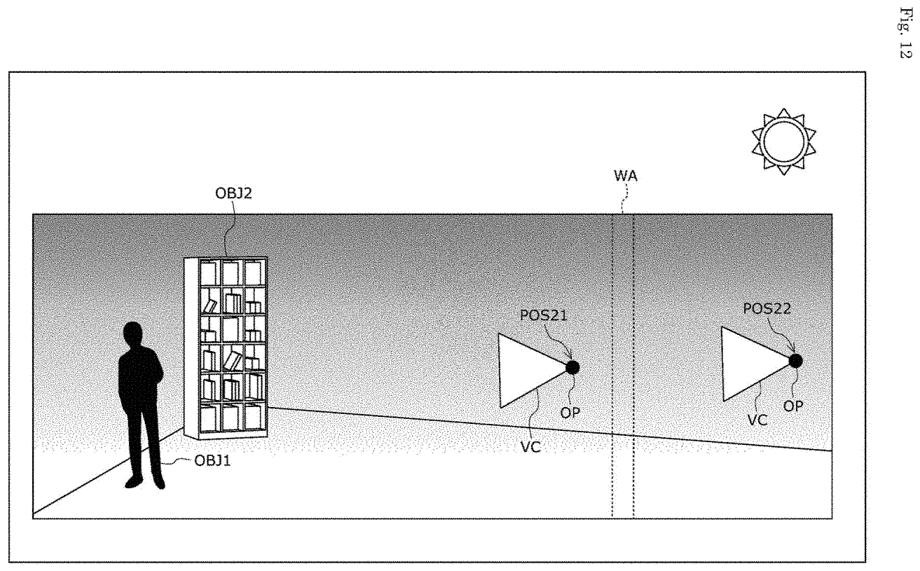

The VC image creation processing in which the transparency processing is performed, which is the processing of step S28, will be described with reference to FIGS. 11 and 12.

FIG. 11 is a diagram of the state where the camera operator OP moves from the indoor position POS21 illustrated in FIG. 10 to the outdoor position POS22, as viewed from the horizontal direction.

For the outdoor position POS22, since the wall WA is present between the virtual camera (imaging device VC) and the person OBJ1 that is the subject of interest, the wall WA is detected as an obstacle and the wall WA is to be subjected to the transparency processing as an avoidance object. In this case, if the wall WA is simply subjected to the transparency processing, the indoor brightness may be affected by the outdoor brightness (for example, the indoor space appears brighter), or there may be an influence such as the outdoor ground or sky appearing in the imaging range, because the virtual camera is outdoors.

As described above, when a first space (indoor) in which the subject of interest is present and a second space (outdoor) in which the virtual camera is present are different from each other, the image creation unit 34 performs the transparency processing for the avoidance object and in addition, creates a VC image on the imaging conditions (for example, white balance, etc.) for and environment (for example, floor surface, ceiling, etc.) of the first space in which the subject of interest is present, as illustrated in FIG. 12. More specifically, the image creation unit 34 creates a VC image by performing continuous environment processing to make the environment of the virtual space VS continuous, such as changing the outdoor image to an image with an extended indoor floor or ceiling, changing the white balance to the indoor brightness instead of the outdoor brightness, or the like.

Returning to FIG. 8, in step S29 for the third avoidance mode being selected as the avoidance mode, the avoidance mode selection control unit 31 causes the virtual camera position control unit 33 to change the position of the virtual camera corresponding to the position of the imaging device VC in the real space RS so that the virtual camera does not come into contact with the obstacle.

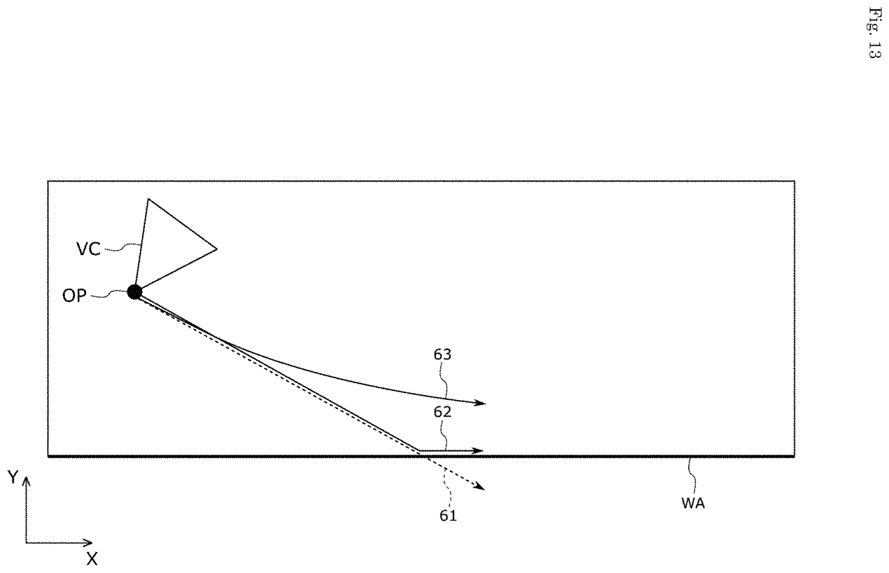

FIG. 13 illustrates an example of control for changing the position of the virtual camera corresponding to the position of the imaging device VC, which is performed by the virtual camera position control unit 33 as the processing of step S29.

For example, it is assumed that the movement path or predicted path of the imaging device VC estimated by the device position estimation apparatus 12 is a track 61, and the imaging device VC collides with the wall WA which is an obstacle.

As a first change control of the virtual camera position, the virtual camera position control unit 33 controls the position of the virtual camera, as on a track 62, so that the position of the virtual camera does not change in response to a change in the position in the direction in which the obstacle is present. Assume that the horizontal direction is an X direction and the vertical direction is a Y direction in FIG. 13. The position of the imaging device VC (track 61) coincides with and the position of the virtual camera on the track 62 until the track 62 reaches the wall WA. However, the position of the virtual camera does not change in the Y direction after the track 62 reaches the wall WA.

Alternatively, as a second change control of the virtual camera position, the virtual camera position control unit 33 changes the amount of movement of the virtual camera corresponding to the amount of movement of the imaging device VC in the real space RS, as on a track 63. Specifically, since the direction in which the wall WA is present is the Y direction, the ratio of the amount of movement of the virtual camera to the amount of movement of the imaging device VC in the Y direction is changed. For example, the amount of movement of the virtual camera is set to ½ of the amount of movement of the imaging device VC, and for the Y direction, the amount of movement of the virtual camera is set to “5” for the amount of movement “10” of the imaging device VC.

In the control for changing the position of the virtual camera in step S29 of FIG. 8, the virtual camera position control unit 33 performs the first change control corresponding to the track 62 or the second change control corresponding to the track 63, described with reference to FIG. 13.

Then, in step S30 of FIG. 8, the image creation unit 34 executes the VC image creation processing in which a two-dimensional image (VC image) of the virtual space VS corresponding to the imaging range of the virtual camera is created based on the position of the virtual camera after the position of the virtual camera is controlled to be changed. This VC image creation processing is the same processing as step S4 of FIG. 7.

When the VC image creation processing of step S23, S26, S28, or S30 is completed, steps S5 to S7 of FIG. 7 are executed.

According to the above-described obstacle-adaptive VC image creation processing, the obstacle detection unit 32 of the image processing apparatus 13 detects an obstacle in the virtual space VS with respect to the virtual camera based on the camera position and attitude information identified based on the device position and attitude information indicating the position and attitude in the real space RS of the imaging device VC for capturing an image of the virtual space VS, the camera position and attitude information indicating the position and attitude of the virtual camera in the virtual space VS associated with the real space RS.

Then, when an obstacle is detected, the image processing apparatus 13 executes the first avoidance processing to the third avoidance processing according to the first to third avoidance modes selected by the avoidance mode switching button 45. When the first avoidance mode is selected, the image processing apparatus 13 displays an alert screen for notification of a collision with an obstacle. When the second avoidance mode is selected, the image processing apparatus 13 creates and displays a VC image in which transparency processing is performed on the obstacle. When the third avoidance mode is selected, the image processing apparatus 13 changes the position of the virtual camera corresponding to the position of the imaging device VC so that the virtual camera does not collide with the obstacle.

This makes it possible for the camera operator OP to recognize an obstacle in the virtual space VS that is not present in the real space RS, and also makes it possible to prevent the camera operator OP from taking the image of an object different from an object whose image is originally intended to be captured.

The camera operator OP can freely switch between enabling and disabling the first to third avoidance modes by operating the avoidance mode on/off button 44 displayed on the display 21 of the imaging device VC. Further, by operating the avoidance mode switching button 45, the first to third avoidance modes can be freely selected.

In the above-described examples, when the first avoidance mode is selected, an alert screen for notification of a collision with the obstacle is displayed on the display 21 of the imaging device VC to notify the camera operator OP who is the user of the imaging device VC that the obstacle has been detected. However, the notification method for obstacle detection is not limited to this.

For example, the obstacle having been detected may be notified to the camera operator OP, for example, by vibrating a handle of the imaging device VC and/or outputting an alarm sound from the imaging device VC. Further, two or more of displaying the alert screen, vibrating the imaging device VC, and outputting the alarm sound may be performed at the same time. As a notification method for notification of the detection of an obstacle, for the handle or the like of the imaging device VC being vibrated, the imaging device VC is provided with a vibration element or the like. Further, as a notification method for notification of the detection of an obstacle, for an alarm sound or the like being output, the imaging device VC is provided with a speaker or the like.

In addition, at the timing when any of the avoidance modes is set to be enabled, an obstacle is detected, and then any of the first avoidance processing to the third avoidance processing is executed, the image creation unit 34 of the image processing apparatus 13 may cause the display 21 to display that predetermined avoidance processing is being executed, for example, “Second avoidance processing is being executed”. This makes it possible for the camera operator OP to recognize that the avoidance processing is being executed.

### 4. Modification Example of Image Processing System

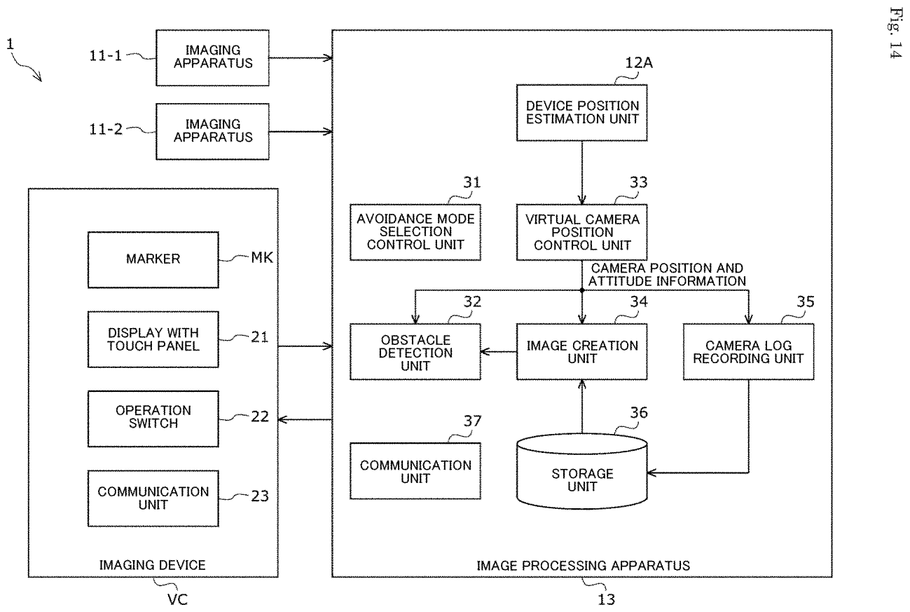

FIG. 14 is a block diagram illustrating a modification example of the image processing system illustrated in FIG. 5.

In the modification example of FIG. 14, portions corresponding to those of the image processing system 1 illustrated in FIG. 5 are denoted by the same reference numerals and signs, and description of the portions will be appropriately omitted.

The image processing system 1 of FIG. 14 includes the imaging device VC, the two imaging apparatuses 11 (11-1, 11-2), and the image processing apparatus 13, and a device position estimation unit 12A, which corresponds to the device position estimation apparatus 12 illustrated in FIG. 5, is incorporated as a part of the image processing apparatus 13.

As described above, the image processing apparatus 13 can have the function of estimating the position and attitude of the imaging device VC based on the captured image supplied from each of the two imaging apparatuses 11.

Also in this case, the same advantageous effects as those of the image processing system 1 illustrated in FIG. 5 can be obtained. Specifically, the first avoidance processing to the third avoidance processing can be executed according to the first to third avoidance modes selected by the camera operator OP, and the camera operator OP can recognize an obstacle in the virtual space VS that is not present in the real space RS. This makes it possible to prevent the camera operator OP from taking the image of an object different from an object whose image is originally intended to be captured.

### 5. Configuration Example of Single Imaging Device

The image processing system 1 of FIGS. 5 and 14 has a configuration that employs a so-called outside-in position estimation, in which the position and attitude of the imaging device VC are estimated based on the captured image(s) captured by the imaging apparatus(es) 11. For the outside-in position estimation, it is necessary to prepare a sensor for tracking outside the imaging device VC.

On the other hand, it is also possible to adopt a so-called inside-out position estimation in which the imaging device VC itself is provided with a sensor for position and attitude estimation, and that device estimates its own position and attitude. In this case, the imaging device VC itself may have the functions of the image processing apparatus 13, so that the above-described functions implemented by the image processing system 1 can be provided by only one imaging device VC.

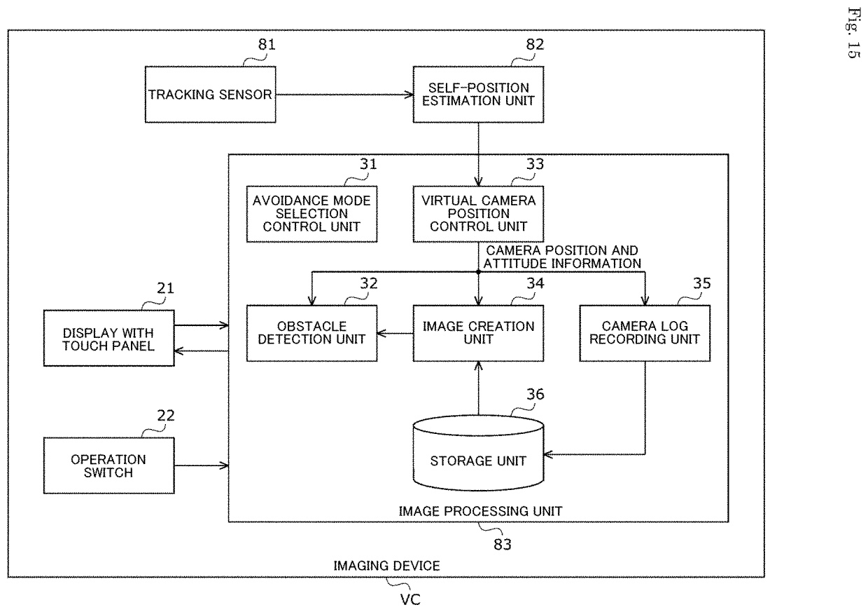

FIG. 15 is a block diagram illustrating a configuration example of the imaging device VC in the case where the functions implemented by the image processing system 1 are implemented by one imaging device VC.

In FIG. 15, portions corresponding to those of the image processing system 1 illustrated in FIG. 5 are denoted by the same reference numerals and signs, and description of the portions will be appropriately omitted.

The imaging device VC includes the display 21 with a touch panel, the operation switch 22, a tracking sensor 81, a self-position estimation unit 82, and an image processing unit 83.

The image processing unit 83 includes the avoidance mode selection control unit 31, the obstacle detection unit 32, the virtual camera position control unit 33, the image creation unit 34, the camera log recording unit 35, and the storage unit 36.

Comparing the configuration of the imaging device VC of FIG. 15 with the configuration of the image processing system 1 of FIG. 5, the imaging device VC of FIG. 15 has the configuration of the image processing apparatus 13 of FIG. 5 as the image processing unit 83. Note that, in the imaging device VC of FIG. 15, the marker(s) MK, the communication unit 23, and the communication unit 37 of FIG. 5 are omitted. The tracking sensor 81 corresponds to the imaging apparatuses 11-2 and 11-2 of FIG. 5, and the self-position estimation unit 82 corresponds to the device position estimation apparatus 12 of FIG. 5.

The display 21 displays the display image created by the image creation unit 34, and supplies an operation signal corresponding to a touch operation from the camera operator OP detected on the touch panel to the image processing unit 83. The operation switch 22 supplies an operation signal corresponding to an operation from the camera operator OP to the image processing unit 83.

The tracking sensor 81 includes at least one sensor such as an imaging sensor and an inertial sensor. The imaging sensor as the tracking sensor 81 captures an image of the surroundings of the imaging device VC, and supplies the resulting captured image as sensor information to the self-position estimation unit 82. A plurality of imaging sensors may be provided to capture images in all directions. Further, the imaging sensor may be a stereo camera composed of two imaging sensors.

The inertial sensor as the tracking sensor 81 includes sensors such as a gyro sensor, an acceleration sensor, a magnetic sensor, and a pressure sensor, and measures and supplies angular velocity, acceleration, and the like, as sensor information to the self-position estimation unit 82.

The self-position estimation unit 82 estimates (detects) its own position and attitude (i.e., of the imaging device VC) based on the sensor information from the tracking sensor 81. For example, the self-position estimation unit 82 estimates its own position and attitude by Visual-SLAM (Simultaneous Localization and Mapping) using the feature points of the captured image captured by the imaging sensor as the tracking sensor 81. Further, in the case where an inertial sensor such as a gyro sensor, an acceleration sensor, a magnetic sensor, or a pressure sensor is provided, the self-position and attitude can be estimated with high accuracy by using the sensor information thereof. The self-position estimation unit 82 supplies device position and attitude information indicating its own estimated position and attitude to the virtual camera position control unit 33 of the image processing unit 83.

The imaging device VC having the above-described configuration can implement the functions implemented by the image processing system 1 of FIG. 5 only by internal processing. Specifically, the first avoidance processing to the third avoidance processing can be executed according to the first to third avoidance modes selected by the camera operator OP, and the camera operator OP can recognize an obstacle in the virtual space VS that is not present in the real space RS. This makes it possible to prevent the camera operator OP from taking the image of an object different from an object whose image is originally intended to be captured.

In the above-described examples, a predetermined one is selected from the first to third avoidance modes, and the avoidance processing for the selected avoidance mode is executed. However, the first avoidance mode may be selected and executed at the same time as the second avoidance mode or the third avoidance mode.

For example, in the case where both the first avoidance mode and the second avoidance mode are selected, when an obstacle is detected, an alert screen is displayed on the display 21, and then when the camera operator OP moves to the outside of the wall WA, the image processing apparatus 13 (or the image processing unit 83) creates a VC image in which the transparency processing is performed on the wall WA, and causes the display 21 to display the VC image.

For example, in the case where both the first avoidance mode and the third avoidance mode are selected, when an obstacle is detected, an alert screen is displayed on the display 21, and then when the camera operator OP approaches the wall WA, the image processing apparatus 13 (or the image processing unit 83) changes the ratio between the amount of movement of the imaging device VC in the Y direction and the amount of movement of the virtual camera, and controls the position of the virtual camera so that the virtual camera does not reach the wall WA.

### 6. Configuration Example of Computer

The above-described series of processing can also be performed by hardware or software. When the series of steps of processing is performed by software, a program of the software is installed in a computer. Here, the computer includes a microcomputer which is embedded in dedicated hardware or, for example, a general-purpose personal computer capable of executing various functions by installing various programs.

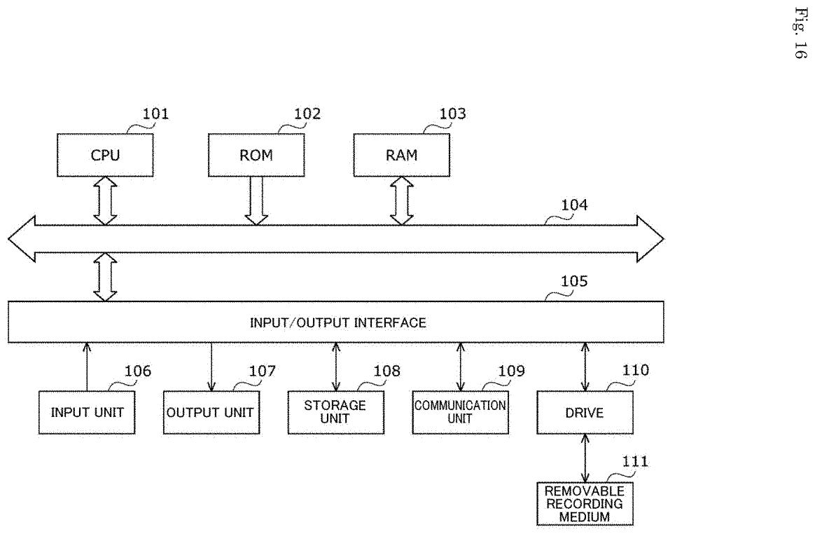

FIG. 16 is a block diagram showing an example of a hardware configuration of a computer that executes the above-described series of processing according to a program.

In the computer, a central processing unit (CPU) 101, a read only memory (ROM) 102, and a random access memory (RAM) 103 are connected to each other by a bus 104.

An input/output interface 105 is further connected to the bus 104. An input unit 106, an output unit 107, a storage unit 108, a communication unit 109, and a drive 110 are connected to the input/output interface 105.

The input unit 106 is, for example, a keyboard, a mouse, a microphone, a touch panel, or an input terminal. The output unit 107 is, for example, a display, a speaker, or an output terminal. The storage unit 108 is, for example, a hard disk, a RAM disc, or a nonvolatile memory. The communication unit 109 is a network interface or the like. The drive 110 drives a removable recording medium 111 such as a magnetic disk, an optical disc, a magneto-optical disc, or a semiconductor memory.

In the computer configured as described above, for example, the CPU 101 loads a program stored in the storage unit 108 into the RAM 103 via the input/output interface 105 and the bus 104 and executes the program to perform the series of processing described above. The RAM 103 also appropriately stores data and the like necessary for the CPU 101 to execute various types of processing.

The program executed by the computer (the CPU 101) can be recorded on, for example, the removable recording medium 111 serving as a package medium for supply. The program can be supplied via a wired or wireless transmission medium such as a local area network, the Internet, or digital satellite broadcasting.

In the computer, by mounting the removable recording medium 111 on the drive 110, it is possible to install the program in the storage unit 108 via the input/output interface 105. The program can be received by the communication unit 109 via a wired or wireless transfer medium to be installed in the storage unit 108. In addition, this program may be installed in advance in the ROM 102 or the storage unit 108.

In the present description, the steps having been described in the flowcharts may be carried out in parallel or with necessary timing, for example, when evoked, even if the steps are not executed in time series along the order having been described therein, as well as when the steps are executed in time series.

In the present specification, a system is a collection of a plurality of constituent elements (devices, modules (components), or the like) and all the constituent elements may be located or not located in the same casing. Accordingly, a plurality of devices stored in separate casings and connected via a network and a single device in which a plurality of modules are stored in one casing are all systems.

The embodiments of the present technology are not limited to the aforementioned embodiments, and various changes can be made without departing from the gist of the present technology.

For example, a combination of all or part of the above-mentioned plurality of embodiments may be employed.

For example, the present technology may have a configuration of clouding computing in which a plurality of devices share and process one function together via a network.

In addition, each step described in the above flowchart can be executed by one device or shared by a plurality of devices.

Further, in a case in which one step includes a plurality of processes, the plurality of processes included in the one step can be executed by one device or shared and executed by a plurality of devices.

The advantageous effects described in the present specification are merely exemplary and are not limited, and other advantageous effects of the advantageous effects described in the present specification may be achieved.

The present technology can be configured as follows.

(1) An image processing apparatus including a detection unit that detects an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.

(2) The image processing apparatus according to (1), wherein the detection unit detects an obstacle in the virtual space based on a relationship between the camera position and attitude information and a position of an object in the virtual space.

(3) The image processing apparatus according to (1) or (2), wherein the detection unit detects an obstacle in the virtual space based on a relationship between the camera position and attitude information and predicted movement position information of the virtual camera and a position of an object in the virtual space.

(4) The image processing apparatus according to any one of (1) to (3), wherein the detection unit detects an obstacle in the virtual space based on a relationship between the camera position and attitude information and predicted movement position information of an object moving in the virtual space.

(5) The image processing apparatus according to any one of (1) to (4), wherein the detection unit detects an obstacle in the virtual space based on the camera position and attitude information and a positional relationship between a subject of interest for the virtual camera in the virtual space and a neighboring subject which is a subject around the subject of interest.

(6) The image processing apparatus according to any one of (1) to (5), further including a notification unit that notifies a user of the imaging device that the obstacle has been detected by the detection unit.

(7) The image processing apparatus according to (6), wherein the notification unit vibrates the imaging device to notify the user of the imaging device that the obstacle has been detected.

(8) The image processing apparatus according to (6) or (7), wherein the notification unit changes a display method of a display unit of the imaging device to notify the user of the imaging device that the obstacle has been detected.

(9) The image processing apparatus according to any one of (6) to (8), wherein the notification unit causes a display unit of the imaging device to display a message to notify the user of the imaging device that the obstacle has been detected.

(10) The image processing apparatus according to any one of (6) to (9), wherein the notification unit causes the imaging device to output a sound to notify the user of the imaging device that the obstacle has been detected.

(11) The image processing apparatus according to any one of (1) to (10), further including an image creation unit that creates an image of the virtual space corresponding to an imaging range of the virtual camera.

(12) The image processing apparatus according to (11), wherein when the detection unit detects the obstacle, the image creation unit creates an image of the virtual space in which transparency processing is performed on the obstacle.

(13) The image processing apparatus according to (11) or (12), wherein when an imaging condition for a first space in which an imaging target object of the virtual camera is present and an imaging condition for a second space in which the virtual camera is present are different from each other, the image creation unit creates an image of the virtual space on the imaging condition for the first space.

(14) The image processing apparatus according to any one of (11) to (13), wherein when a first space in which an imaging target object of the virtual camera is present and a second space in which the virtual camera is present are different from each other, the image creation unit creates an image of the virtual space in the first space.

(15) The image processing apparatus according to any one of (1) to (14), further including a virtual camera position control unit that identifies the position of the virtual camera corresponding to the position of the imaging device in the real space, wherein when the detection unit detects the obstacle, the virtual camera position control unit changes a change in the position of the virtual camera corresponding to a change in the position of the imaging device in the real space.

(16) The image processing apparatus according to (15), wherein when the detection unit detects the obstacle, the virtual camera position control unit controls the virtual camera so that the position of the virtual camera does not change in response to a change in the position of the imaging device in a predetermined direction in the real space.

(17) The image processing apparatus according to (15), wherein when the detection unit detects the obstacle, the virtual camera position control unit changes an amount of movement of the virtual camera corresponding to an amount of movement of the imaging device in the real space.

(18) The image processing apparatus according to any one of (1) to (17), further including a selection unit that selects a method of avoiding the obstacle detected by the detection unit.

(19) An image processing method including, by an image processing apparatus, detecting an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.

(20) A program causing a computer to execute processing of detecting an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.

(21) An imaging device including: a selection unit that selects a method of avoiding an obstacle when the obstacle is detected, based on camera position and attitude information identified based on device position and attitude information indicating a position and an attitude in a real space of an imaging device for capturing an image of a virtual space, the camera position and attitude information indicating a position and an attitude of a virtual camera in the virtual space associated with the real space; a display unit that displays an image of the virtual space corresponding to an imaging range of the virtual camera; and an operation unit that allows an adjustment operation on the image of the virtual camera.

### REFERENCE SIGNS LIST

VC Imaging device

VS Virtual space

RS Real space

WA Wall

OBJ 3D object

OP Camera operator

VCa Collision range

1 Image processing system

11 Imaging apparatus

12 Device position estimation apparatus

13 Image processing apparatus

21 Display

22 Operation switch

31 Avoidance mode selection control unit

32 Obstacle detection unit

33 Virtual camera position control unit

34 Image creation unit

35 Camera log recording unit

36 Storage unit

42 Rendered image display unit

43 Top view display unit

44 Avoidance mode on/off button

45 Avoidance mode switching button

81 Tracking sensor

82 Self-position estimation unit

83 Image processing unit

101 CPU

102 ROM

103 RAM

106 Input unit

107 Output unit

108 Storage unit

109 Communication unit

110 Drive

1. An image processing apparatus comprising a detection unit that detects an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.

2. The image processing apparatus according to claim 1, wherein the detection unit detects an obstacle in the virtual space based on a relationship between the camera position and attitude information and a position of an object in the virtual space.

3. The image processing apparatus according to claim 1, wherein the detection unit detects an obstacle in the virtual space based on a relationship between the camera position and attitude information and predicted movement position information of the virtual camera and a position of an object in the virtual space.

4. The image processing apparatus according to claim 1, wherein the detection unit detects an obstacle in the virtual space based on a relationship between the camera position and attitude information and predicted movement position information of an object moving in the virtual space.

5. The image processing apparatus according to claim 1, wherein the detection unit detects an obstacle in the virtual space based on the camera position and attitude information and a positional relationship between a subject of interest for the virtual camera in the virtual space and a neighboring subject which is a subject around the subject of interest.

6. The image processing apparatus according to claim 1, further comprising a notification unit that notifies a user of the imaging device that the obstacle has been detected by the detection unit.

7. The image processing apparatus according to claim 6, wherein the notification unit vibrates the imaging device to notify the user of the imaging device that the obstacle has been detected.

8. The image processing apparatus according to claim 6, wherein the notification unit changes a display method of a display unit of the imaging device to notify the user of the imaging device that the obstacle has been detected.

9. The image processing apparatus according to claim 6, wherein the notification unit causes a display unit of the imaging device to display a message to notify the user of the imaging device that the obstacle has been detected.

10. The image processing apparatus according to claim 6, wherein the notification unit causes the imaging device to output a sound to notify the user of the imaging device that the obstacle has been detected.

11. The image processing apparatus according to claim 1, further comprising an image creation unit that creates an image of the virtual space corresponding to an imaging range of the virtual camera.

12. The image processing apparatus according to claim 11, wherein when the detection unit detects the obstacle, the image creation unit creates an image of the virtual space in which transparency processing is performed on the obstacle.

13. The image processing apparatus according to claim 12, wherein when an imaging condition for a first space in which an imaging target object of the virtual camera is present and an imaging condition for a second space in which the virtual camera is present are different from each other, the image creation unit creates an image of the virtual space on the imaging condition for the first space.

14. The image processing apparatus according to claim 12, wherein when a first space in which an imaging target object of the virtual camera is present and a second space in which the virtual camera is present are different from each other, the image creation unit creates an image of the virtual space in the first space.

15. The image processing apparatus according to claim 1, further comprising a virtual camera position control unit that identifies the position of the virtual camera corresponding to the position of the imaging device in the real space, wherein
when the detection unit detects the obstacle, the virtual camera position control unit changes a change in the position of the virtual camera corresponding to a change in the position of the imaging device in the real space.

16. The image processing apparatus according to claim 15, wherein when the detection unit detects the obstacle, the virtual camera position control unit controls the virtual camera so that the position of the virtual camera does not change in response to a change in the position of the imaging device in a predetermined direction in the real space.

17. The image processing apparatus according to claim 15, wherein when the detection unit detects the obstacle, the virtual camera position control unit changes an amount of movement of the virtual camera corresponding to an amount of movement of the imaging device in the real space.

18. The image processing apparatus according to claim 1, further comprising a selection unit that selects a method of avoiding the obstacle detected by the detection unit.

19. An image processing method comprising, by an image processing apparatus, detecting an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.

20. A program causing a computer to execute processing of:
detecting an obstacle in a virtual space with respect to a virtual camera based on camera position and attitude information identified based on device position and attitude information indicating a position and an attitude in the real space of an imaging device for capturing an image of the virtual space, the camera position and attitude information indicating a position and an attitude of the virtual camera in the virtual space associated with the real space.
